(19) United States
(12) Patent Application Publication
(10) Pub. No.: US 2009/0252904 A1
(43) Pub. Date: Oct. 8, 2009

(54) METHOD FOR THE PRODUCTION OF MACHINERY COMPONENTS AND SUBSEQUENTLY PRODUCED ROLL SLEEVE

(76) Inventors: Herbert Weinberger, Lilienfeld (AT); Florian Hochreiter, Pyhra (AT)

Correspondence Address: TAYLOR & AUST, P.C., P.O. Box 560, 142. S Main Street, Avilla, IN, 46710, US

(21) Appl. No.: 12/419,578

(22) Filed: Apr. 7, 2009

(30) Foreign Application Priority Data
Apr. 8, 2008 (DE) 10 2008 001 052.9
Jul. 31, 2008 (DE) 10 2008 040 910.3

(51) Int. Cl. B32B 3/10; C21D 9/08; C21D 1/42; C21D 1/34; B32B 1/08; B21D 53/00

(52) U.S. Cl. 428/34.1; 148/559; 148/570; 148/565; 29/895

(57) ABSTRACT

A method for the production of mechanically highly stressed machinery components, with at least one pass-through opening, especially suction roll sleeves on paper machines, includes the material characteristics of the machinery component being altered with regard to an increase in the resistance against vibratory fissure corrosion on the machinery component in the localized area of the pass-through opening. A roll sleeve produced according to this method is also provided.

### BACKGROUND OF THE INVENTION

1. Field of the Invention

The current invention relates to a method for the production of mechanically highly stressed machinery components, with at least one pass-through opening, especially suction roll sleeves on paper machines.

In addition, the current invention relates to roll sleeves with at least one pass-through opening, especially suction roll sleeves for paper machines.

2. Description of the Related Art

Rolls in the wet section of paper machines are permanently stressed during operation by chemically aggressive mediums. Customarily, such machinery components are protected against corrosion by lacquers, paints, or special coating materials. Since the transition from the drilled hole sleeve surface to the roll sleeve surfaces is sharp-edged, the adhesive properties of the coating are critical in that location. Beyond that, the coating in the area of the hole wall should be established with very little surface roughness, in order to prevent clogging of the suction roll holes.

In order to ensure corrosion protection suction roll sleeves are produced from special materials in which a passive layer forms independently due to the material alloy. Under certain conditions this protective layer renews itself after incurring damage, such as scratches, tears or similar damage.

Contingent upon the interaction of the permanent effect of corrosive mediums on defective locations in the protective layer and the mechanical, generally dynamic, tensions in the material any suction roll sleeve will fatigue. So-called vibratory fissure corrosion will occur. With certain suction roll types fissure formation will occur medium term, so that the life span is reduced to a few years. A higher quality alloy cannot prevent this fissure formation, but only causes the fissure formation or respectively the fissure development to slow.

What is needed in the art is a method of the type referred to at the beginning, with which the fissure formation on such machinery components can be reduced or avoided.

### SUMMARY OF THE INVENTION

The present invention provides that the material characteristics of the machinery component are being altered with regard to an increase in the resistance against vibratory fissure corrosion in the localized area of the pass-through opening.

It was discovered that, according to the invention, it is sufficient to increase the resistance against vibratory fissure corrosion in the area of the pass-through opening. While very high tensile strengths prevail at the hole edge they drop within less than one tenth of a millimeter into a non-critical range. It is therefore not necessary to increase the resistance against vibratory fissure corrosion over larger areas, or even over the entire surface.

A substantially greater lifespan can be achieved through the inventive method. Or, more economical materials may be utilized for the same lifespan. In both instances the life cycle costs are reduced.

The increase in stability can occur through the introduction of internal stresses or through structural change. The internal stresses can be produced particularly mechanically, and the structural changes can be produced thermally. A mechanical creation of internal stresses occurs preferably through plastic deformation and thermal change of the material structure preferably through local heating and rapid cooling.

The introduction of internal stresses has the advantage that the critical tensile stress responsible for material failure is reduced by superimposition of these internal stresses with the stresses caused by outside stress.

It has been noticed that the introduction of internal stresses in an area of a few tenths millimeters around the edge of the pass-through opening is sufficient to clearly increase the life span. It has also been noticed that it may be sufficient to provide internal stresses only in an area close to the surface of the machinery component, whereby this is possible on only one side, or on both sides of the machinery component. The characteristics in the remaining areas, for example the roughness of the surface, are not influenced by this localized creation of internal stresses.

Significantly, the internal stresses are created after the fabrication of the pass-through openings.

According to one embodiment of the invention a tool such as a ball or plunger which has a larger diameter than the pass-through opening are inserted through the pass-through opening. This causes a mechanical pressure to be exerted on the wall of the pass-through opening and the area near the surface of same, which can create the desired internal stresses. The over-dimension is preferably between approx. 0.5 μm and approx. 15 μm.

The exertion of pressure on the wall of the pass-through opening and/or its areas near the surface can also occur hydrostatically. A hollow mandrel could for example be inserted in the pass-through opening and could be expanded through the introduction of a pressure medium.

Basically, the inventive method can be applied with various materials, especially with metals.

Especially on so-called duplex steels the stability of the machinery component can be improved through changing the material structure in the area of the pass-through opening. Changing of the material structure can occur especially through heating and subsequent rapid cooling of the edge area. Heating to above 1000° C. has proven suitable. Heating can occur inductively or by way of plasma technology or laser. The ferritic component which is increased due to heating is stabilized through the rapid cooling.

An induction coil may for example be inserted into the pass-through opening to generate inductive heating. The preferably water-cooled induction coil heats the outermost edge layer of the bore. When heating through plasma technology, a hollow electrode with radial holes can be inserted into the bore. Protective gas is routed through the radial holes. By feeding a voltage between the electrode and the machinery component, a plasma is produced which brings the material on the wall of the pass-through opening to the desired temperature. This can be accomplished within a few seconds.

Because the high temperature is introduced only in the edge area of the pass-through opening or, respectively only to a slight depth, the self-cooling capacity through the heat flow in the material is oftentimes sufficient. Auxiliary cooling can otherwise be provided, for example water cooling. A rapid cooling can hereby be ensured.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIGS. 1a-c are three phases of a pressure feed through a hollow mandrel;

FIG. 2 is a cross section through a bore hole in a roll sleeve, with the internal stress progression that is to be introduced through the tool;

FIG. 3a is a boring tool with a conventional positive effective cutting angle (state of the art);

FIG. 3b is a boring tool with negative cutting phase;

FIG. 4 is a cross section through a bore hole in a roll sleeve with plunger-type tool;

FIG. 5 is a cross section through a bore hole in a roll sleeve with inserted hollow electrode; and

FIG. 6 is a cross section through a bore hole in a roll sleeve with the temperature progression drawn in.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

Referring now to the drawings, and more particularly to FIG. 1, there is shown how internal pressure stresses are created in the area of the bore 1 of a roll sleeve 2 through the introduction of a hydrostatic pressure into the bore 1. For this purpose a hollow mandrel 3 is inserted with clearance into the previously bored hole 1, as indicated by arrow 4 in FIG. 1a. Following complete insertion of the hollow mandrel 3 according to FIG. 1b a pressure medium is introduced into the hollow mandrel 3 and the internal pressure in the hollow mandrel 3 is increased so that it expands, as depicted in FIG. 1c. The pressure thereby exerted on the wall 5 of the bore 1 is indicated by arrows 6. After creation of the desired internal pressure stresses the pressure medium is evacuated from the hollow mandrel 3 and, after returning to its original form the hollow mandrel 3 is extracted from the bore 1.

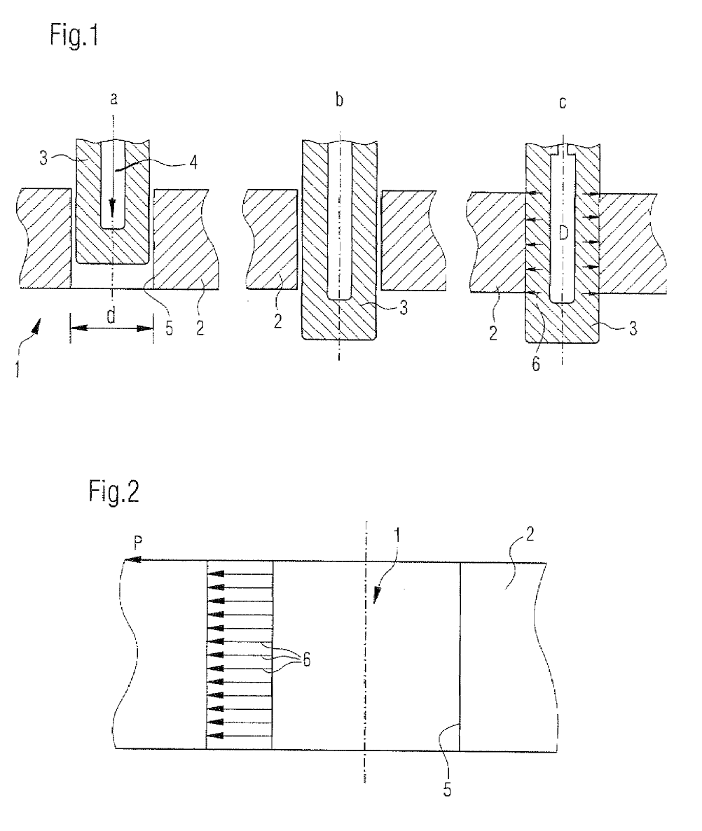

The internal pressure stresses created through these methods are illustrated in FIG. 2. The pressure progression is depicted over the bore depth as P1. The arrows 6 identify the introduced hydrostatic pressure. As can be seen, the introduced pressure stresses remain relatively constant over the entire bore depth. This is consistent with the progression of the tensile stresses when the roll sleeve is under pressure and thereby counteracts a vibratory fissure corrosion, as desired.

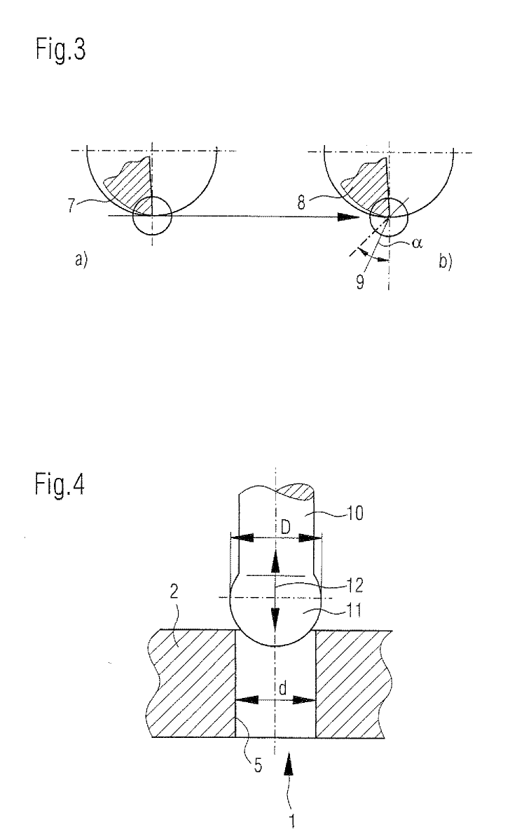

FIG. 3 illustrates how internal pressure stresses can be created in a bore 1 through mechanical processing. FIG. 3a shows the treatment of an already existing bore with a conventional bore tool. FIG. 3b shows a tool 8 which consists of a combination of a bore tool and a plastic deformation tool and which is equipped with a negative cutting phase 9 to produce the internal pressure stresses. The negative cutting phase has a size of preferably approx. 0.05 mm to approx. 0.2 mm.

An additional variation is illustrated in FIG. 4. Here, a plunger-type tool 10 with an expanded head, for example a spherical head 11 is inserted into the bore 1. The diameter D of the head 11 is then approx. 0.5 to approx. 15 μm larger than the diameter d of the bore 1. The insertion and extraction occurs according to the double arrow 12.

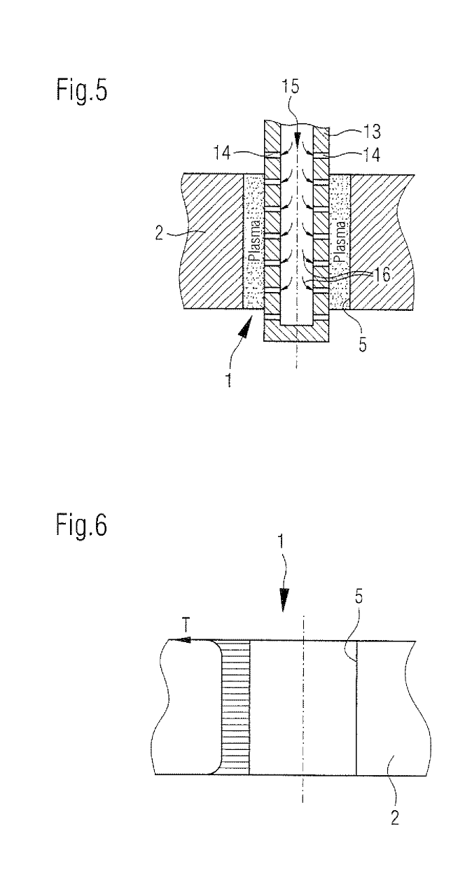

FIG. 5 illustrates the introduction of a high temperature into the wall area of the bore 1, for a change in the structure of the material near the surface. This occurs for example, as illustrated by way of a hollow electrode 13 which is equipped with radial holes 14. According to arrow 15 protective gas is fed into the hollow electrode which then is emitted through the radial holes 14 as indicated by the arrows 16. A plasma is then produced between the hollow electrode 13 and the roll sleeve 2 by feeding a voltage which brings the material of the roll sleeve 2 at the bore wall to the desired temperature, especially higher than 1000° C. Heating occurs only over the duration of a few seconds. The roll sleeve 2 is then cooled which may occur simply through the heat loss in the material itself, in other words through a self cooling capacity of the material. Should this not be sufficient a separate cooling, for example water cooling, may be provided.

The temperature progression created in the bore by the plasma is illustrated in FIG. 6. The temperature T is plotted over the bore depth. As can be seen, it is greatest in the edge areas. This produces a structure change in the roll material whereby the phase relationship between ferritic steel and austenitic steel can be altered so that a ferrite share of greater than 70% to 99.9% is achieved in the area of the bore and especially at the bore edges. Thus the material characteristics with regard to the vibratory fissure corrosion in the area of the bore, in other words in the critical zones are determined through the ferrite share. The phase shares remain unchanged in the other areas, so that the advantageous characteristic of the austenitic phase are maintained there.

Due to the rapid cooling the condition with high ferrite content which existed previously at an elevated temperature is maintained. Since this hardening through increase of the ferrite share is necessary only in the area of the bores, and there only in the edge areas, the introduction of a relatively small amount of heat suffices. Accordingly, the cooling can be accomplished relatively easily. In place of the described plasma technology an inductive method can also be used, whereby an induction coil is inserted into the bore hole and high temperatures are created through induction. In addition there is also the possibility to create heating through laser technology.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.
1 Bore
2 Roll sleeve
3 Hollow mandrel
4 Arrow
5 Wall of 1
6 Arrow
7 Tool
8 Tool
9 Cutting phase
10 Plunger
11 Head of 10
12 Double arrow
13 Hollow electrode
14 Radial hole
15 Arrow
16 Arrow
D Diameter of 11
d Diameter of 1
P₁ Pressure progression over the depth of the bore
T Temperature progression over the depth of the bore
α Effective cutting angle

What is claimed is:

1. A method for producing a mechanically highly stressed machinery component on a paper machine, said method comprising the steps of:
providing a machinery component including at least one pass-through opening; and
altering a plurality of material characteristics of said machinery component with regard to an increase in a resistance against vibratory fissure corrosion on said machinery component in a localized area of said machinery component corresponding to said pass-through opening.

2. The method according to claim 1, wherein the mechanically highly stressed machinery component is a suction roll sleeve on the paper machine.

3. The method according to claim 1, wherein said resistance against vibratory fissure corrosion occurs at least one of through introducing a plurality of internal stresses and through a structural change in said machinery component.

4. The method according to claim 3, wherein said plurality of internal stresses are produced mechanically.

5. The method according to claim 3, wherein said plurality of internal stresses are produced mechanically through plastic deformation.

6. The method according to claim 3, wherein said structural change is a change in a material structure of said machinery component, said change in said material structure being achieved through a thermal treatment.

7. The method according to claim 1, wherein said plurality of material characteristics are altered at least one of in an area of up to approximately 1 millimeter around an edge of said pass-through opening and in only one or both areas near a surface of said pass-through opening.

8. The method according to claim 1, wherein said plurality of material characteristics are altered subsequent to having produced said pass-through opening.

9. The method according to claim 1, wherein a tool with a diameter which is larger than a diameter of said pass-through opening is inserted through said pass-through opening.

10. The method according to claim 9, wherein said tool is one of a ball and a plunger.

11. The method according to claim 9, wherein said diameter of said tool is approximately 0.5 μm to approximately 15 μm larger than said diameter of said pass-through opening.

12. The method according to claim 1, wherein a hydrostatic pressure is exerted upon a wall of said pass-through opening.

13. The method according to claim 12, wherein a hollow mandrel is inserted into said pass-through opening and is expanded through introducing a pressure medium.

14. The method according to claim 1, wherein a plurality of internal pressure stresses are introduced at least one of through drilling with a tool with a negative effective cutting angle and through drilling with a tool with an additional negative cutting phase.

15. The method according to claim 1, wherein a material utilized for said machinery component is metal.

16. The method according to claim 15, wherein said metal is one of bronze, steel, and duplex steel.

17. The method according to claim 1, wherein a material structure of said machinery component is altered through heating and subsequent rapid cooling of said localized area corresponding to said pass-through opening.

18. The method according to claim 17, wherein said heating to higher than 1000° C. occurs.

19. The method according to claim 18, wherein said heating to higher than 1000° C. occurs for steels.

20. The method according to claim 18, wherein said heating occurs one of inductively, by plasma technology, and by laser.

21. The method according to claim 20, wherein an induction coil is inserted into said pass-through opening and said heating occurs inductively.

22. The method according to claim 20, wherein a hollow electrode with a plurality of radial holes is inserted into said pass-through opening so that a protective gas is then routed through said plurality of radial holes, and wherein, by feeding a voltage between said hollow electrode and said machinery component, a plasma is produced.

23. The method according to claim 17, wherein an auxiliary cooling is provided.

24. The method according to claim 17, wherein said auxiliary cooling is a water cooling.

25. A roll sleeve for a paper machine, said roll sleeve comprising:
at least one pass-through opening, an increase in a resistance against vibratory fissure corrosion being created through a method including the steps of:
providing a machinery component including at least one said pass-through opening; and
altering a plurality of material characteristics of said machinery component with regard to said increase in said resistance against vibratory fissure corrosion on said machinery component in a localized area of said machinery component corresponding to said at least one pass-through opening.

26. The roll sleeve of claim 25, wherein the roll sleeve is a suction roll sleeve for the paper machine.
